(19) United States
(12) Patent Application Publication
(10) Pub. No.: US 2026/0178575 A1
(43) Pub. Date: Jun. 25, 2026

(54) SYSTEM FOR GENERATING CAUSAL REASONING INSIGHTS IN REAL-TIME AND METHOD THEREOF

(71) Applicant: Course5 Intelligence Limited, Mumbai (IN)

(72) Inventors: Mohan Krishna Rachumallu, Mumbai (IN); Jayachandran Kizhakoot Ramachandran, Mumbai (IN)

(21) Appl. No.: 19/428,999

(22) Filed: Dec. 22, 2025

(30) Foreign Application Priority Data
Dec. 20, 2024 (IN) 202421101287

(51) Int. Cl. G06F 16/2452; G06F 16/2453; G06F 16/26

(52) U.S. Cl. CPC G06F 16/24522; G06F 16/24534; G06F 16/26

(57) ABSTRACT

The invention relates to a system (100) for generating real-time causal reasoning insights in real time. The system (100) comprises a global causal graph creation module (101), a natural language query processing module (102), an information extraction module (103), a query-centric subgraph generation module (104), and an adaptive causal reasoning engine (105). The queries from users are processed to identify relevant causal relationships in the global causal graph. The adaptive causal reasoning engine (105) refines the insights iteratively based on user feedback, improving accuracy. The system (100) converts technical insights into structured narratives. A visualization module presents causal relationships through graphs and charts. The feedback mechanism allows users to correct errors and adjust outputs, facilitating user-driven data analysis and causal reasoning, delivering actionable insights for a variety of applications.

### PREAMBLE TO THE DESCRIPTION

The following specification particularly describes the invention and the manner in which it is to be performed:

### DESCRIPTION OF THE INVENTION

### Technical Field of the Invention

The present invention relates to a system for generating real-time causal reasoning insights from large datasets using Natural Language Processing (NLP) and Large Language Models (LLMs) and adaptive causal inference techniques. The invention further discloses a method for generating real-time causal reasoning insights by integrating natural language queries with a global causal graph, adaptive causal inference, and advanced NLP and LLM techniques to deliver structured, interactive insights.

### BACKGROUND OF THE INVENTION

In today's data-driven world, organizations across various industries generate and collect vast amounts of data. Extracting valuable insights from the collected data, especially causal relationships, is critical for informed decision-making. Further, understanding the cause-and-effect relationships between different variables in large datasets leads to better predictions, improved processes, and optimized outcomes in fields such as business, healthcare, finance, and scientific research.

Traditionally, analyzing causal relationships in data requires domain expertise, specialized knowledge of statistical methods, and complex algorithms. Even with advanced tools, such as machine learning models, deriving actionable causal insights is a time-consuming and technically challenging process. Most existing systems focus on correlation rather than causation, leading to misinterpretations and suboptimal decisions.

Existing statistical and machine learning methods for causal analysis, often lack real-time processing capabilities and are confined to specific domains. Moreover, these methods usually require extensive manual intervention and technical expertise, making them inaccessible to non-expert users. Recent advancements in Natural Language Processing (NLP) and Large Language Models (LLMs) have created opportunities for more intuitive interaction between users and data systems. However, these advancements have yet to be fully harnessed for real-time causal reasoning.

In many industries, such as healthcare, business analytics, and finance, decision-makers often need to understand the underlying causes of observed outcomes or trends. For instance, in healthcare, determining the causal relationship between treatments and patient outcomes is crucial for improving medical practices. Similarly, in business, identifying the causes of changes in consumer behavior or market trends leads to more effective strategies. However, the absence of an efficient, user-friendly system for causal reasoning limits the ability of these professionals to make data-driven decisions in real time.

For instance, PCT Patent Application No. U.S. Pat. No. 8,412,693B2 titled “System and method for providing a natural language interface to a database” discloses a system and method for providing a natural language interface to a database or the Internet. The method provides a response from a database to a natural language query. The method comprises receiving a user query, extracting key data from the user query, submitting the extracted key data to a data base search engine to retrieve a top n pages from the data base, processing of the top n pages through a natural language dialog engine and providing a response based on processing the top and pages.

For instance, U.S. Pat. No. 9,519,862B2 titled “Domains for knowledge-based data quality solution” discloses a knowledge-driven data quality solution that is based on a rich knowledge base. The data quality solution can provide continuous improvement and can be based on continuous (or on-going) knowledge acquisition. The data quality solution can be built once and can be reused for multiple data quality improvements, which can be for the same data or for similar data. The disclosed aspects are easy to use and focus on productivity and user experience. Further, the disclosed aspects are open and extendible and can be applied to cloud-based reference data (e.g., a third party data source) and/or user generated knowledge. According to some aspects, the disclosed aspects can be integrated with data integration services.

Hence, there is a need for a system that seamlessly integrates natural language processing with real-time causal reasoning, enabling users to intuitively interact with large datasets and obtain precise, dynamic causal analyses tailored to their specific queries.

### SUMMARY OF THE INVENTION

The present invention overcomes the drawbacks of the prior art by disclosing a system for generating causal reasoning insights in real time, based on natural language queries. The system leverages advanced Natural Language Processing (NLP) techniques in combination with causal reasoning to analyze complex datasets, enabling users to receive actionable insights and explanations about the causal relationships inherent in the data. The system interprets user queries through a Large Language Model (LLM), enabling intuitive interaction with data without requiring specialized knowledge of causal analysis or underlying data structures.

The system comprises a global causal graph creation module to automatically generate a global causal graph representing causal relationships between multiple data points using a Smart Causal Discovery Engine (SCDE). The system further comprises a natural language query processing module to receive multiple user queries from a user, further interpret and parse user queries using a Large Language Model (LLM). Further, the system comprises an information extraction module to extract relevant data points and attributes from structured and unstructured data sources. Further, a query-centric subgraph generation module is coupled to the global causal graph creation module to generate a query-centric subgraph by isolating causal relationships relevant to the structured query derived from the global causal graph. Furthermore, the system comprises an adaptive causal reasoning engine coupled to the query-centric subgraph generation module to refine the user queries iteratively and generate causal reasoning insights based on the query-centric subgraphs.

Additionally, the system comprises a visualization module to present the causal insights in a clear and intuitive graphical format. The visualization module enables users to comprehend the causal relationships between variables effectively, thereby enhancing their understanding of the data and its implications, facilitating informed decision-making.

The present invention further discloses a method for generating real-time causal reasoning insights based on natural language queries. The method involves generating a global causal graph using a Smart Causal Discovery Engine (SCDE), that preprocesses data, applies multiple causal discovery algorithms, and allows for human intervention to refine the graph based on domain-specific knowledge. Further, the method, generates a structured representation of the user query, upon receiving a natural language query. The structured query is then mapped to the global causal graph, identifying the corresponding data points and causal relationships. Further, a question-centric subgraph is dynamically created from the global causal graph, isolating the relevant nodes and edges to improve computational efficiency. Further, the method refines the user queries iteratively through an adaptive causal reasoning engine, generating multiple causal reasoning insights based on user feedback. Furthermore, the causal reasoning insights are presented to the user through a visualization module that graphically represents the causal links, aiding in user comprehension and decision-making.

The present invention provides a robust and efficient system for causal reasoning analysis, facilitating user interaction with complex datasets through natural language queries, thereby obviating the need for specialized technical expertise. The system employs a global causal graph and dynamically generates query-centric subgraphs isolating and analysing relevant causal relationships, delivering actionable insights tailored to user-specific queries.

### BRIEF DESCRIPTION OF DRAWINGS

FIG. 1 illustrates a block diagram of a system for generating causal reasoning insights in real-time, in accordance with an embodiment of the present invention.

FIG. 2 illustrates a flowchart depicting an operational method of the Smart Causal Discovery Engine (SCDE), in accordance with one embodiment of the present invention.

FIG. 3 illustrates a functional block diagram of the SME-driven graphing tool, in accordance with an embodiment of the present invention.

FIG. 4 illustrates a flowchart of a method for generating causal reasoning insights in real time, in accordance with an embodiment of the present invention.

### DETAILED DESCRIPTION OF THE INVENTION

In order to more clearly and concisely describe and point out the subject matter of the claimed invention, the following definitions are provided for specific terms, which are used in the following written description.

The term “Global Causal Graph” refers to a comprehensive representation of causal relationships among a plurality of variables or events, constructed using a combination of data-driven discovery techniques and domain-specific human inputs.

The term “Query-Centric Subgraph” refers to a dynamically extracted subset of the global causal graph that isolates variables directly or indirectly relevant to a user query.

The term “Adaptive Causal Reasoning Engine” refers to a system component that applies causal inference techniques to query-centric subgraphs to derive insights, leveraging machine learning models and iterative user feedback for enhanced accuracy and relevance.

The term “Natural Language Processing (NLP)” refers to a field of artificial intelligence focused on enabling computers to understand, interpret, and generate human language.

The term “Data Repository” refers to a storage system containing structured and unstructured data, such as schema information, historical queries, and user feedback.

The term “Real-Time Insights” refers to the immediate generation of actionable information based on current data, enabling timely decision-making without delays caused by processing or data retrieval.

The invention relates to a system for generating real-time causal reasoning insights based on natural language queries. The system utilizes advanced Natural Language Processing (NLP) and causal reasoning techniques to analyze complex datasets, enabling users to understand causal relationships within the data. The system comprises a combination of a Large Language Model (LLM) for query interpretation, a global causal graph to represent causal data relationships, and an adaptive causal reasoning engine for refining and processing user queries for achieving actionable insights. The system is applicable across various domains such as healthcare, business analytics, finance, and scientific research.

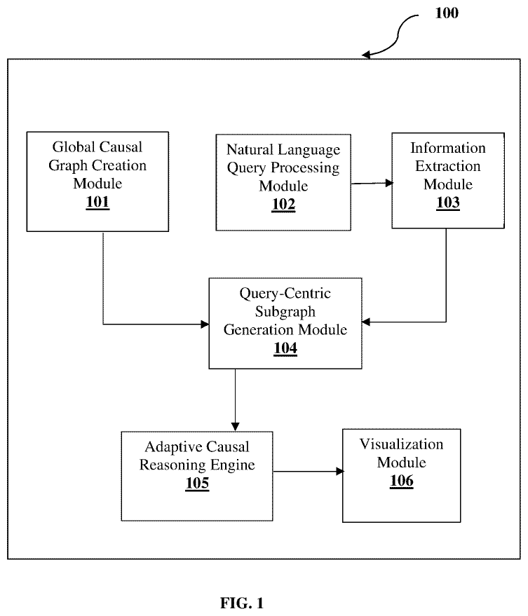

FIG. 1 illustrates a block diagram of a system for generating causal reasoning insights in real-time, in accordance with an embodiment of the present invention. The system (100) comprises a global causal graph creation module (101) to automatically generate a global causal graph representing causal relationships among multiple data points using a Smart Causal Discovery Engine (SCDE). The global causal graph creation module (101) further comprises an editable interface operable through a Subject Matter Expert (SME)-driven graphical tool, enabling domain experts to modify and refine the causal relationships based on domain-specific knowledge, thereby ensuring accurate and domain-relevant causal analysis.

Further, the system (100) comprises a natural language query processing module (102) to receive multiple user queries in natural language from a user. Further, the natural language query processing module (102) parse the user queries to extract relevant information, map the extracted information to elements of the global causal graph and generate the user queries into a structured, machine-readable format.

Further, the system (100) comprises an information extraction module (103) coupled to the natural language query processing module (102). The information extraction module (103) extracts relevant information and attributes from structured and unstructured data sources. The information extraction module (103) selectively filters data to identify and process only the information pertinent to the parsed query received from the natural language query processing module (102). The information extraction module (103) performs the filtering operation to ensure that the extracted data aligns with the structured format of the parsed query, thereby optimizing the subsequent processing and analysis of causal relationships and the generation of actionable insights.

Further, the system (100) comprises a query centric subgraph generation module (104) coupled to the global causal graph creation module (101). The query centric subgraph generation module (104) creates a query-centric subgraph by isolating and extracting causal relationships from the global causal graph that corresponds to the structured query.

Furthermore, the system (100) comprises an adaptive causal reasoning engine (105) coupled to the query-centric subgraph generation module (104). The adaptive causal reasoning engine (105) iteratively refines the queries and processes causal reasoning on the query-centric subgraph generated by the query-centric subgraph generation module (104). More particularly, the adaptive causal reasoning engine (105) processes the query centric subgraph and the user feedback to generate real-time causal reasoning insights.

Additionally, the system (100) comprises a visualization module (106) to present the causal insights and relationships in a graphical format for user interpretation. The visualization module (106) graphically represents the identified causal relationships, facilitating the user's ability to comprehend and analyze the relevant information effectively.

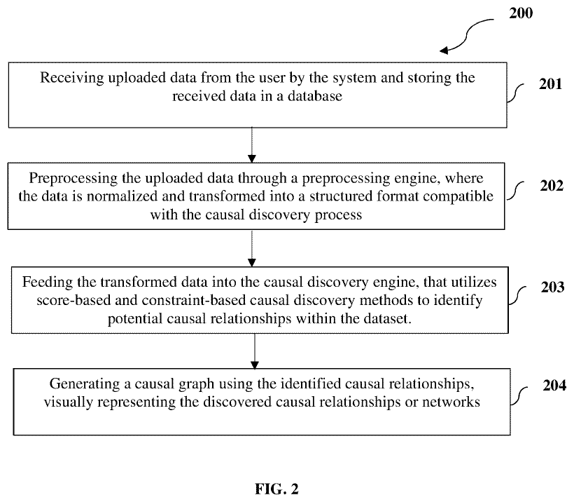

FIG. 2 illustrates a flowchart depicting an operational method of the Smart Causal Discovery Engine (SCDE), in accordance with an embodiment of the present invention. The operational method (200) of the Smart Causal Discovery Engine (SCDE) comprises the steps of receiving uploaded data from the user by the system (100) and storing the received data in a database in step (201). More particularly, the data may include a combination of categorical, numerical, string, or ordinal values requiring pre-processing for further analysis. In step (202), the uploaded data undergoes preprocessing process through a preprocessing engine, where the data is normalized and transformed into a structured format compatible with the causal discovery process. The preprocessing process involves normalizing and transforming the data, addressing issues such as inconsistencies, missing values, and scaling, thereby ensuring the data is in a standardized format compatible with the causal discovery engine. More particularly, the preprocessing step includes encoding categorical variables (for e.g., one-hot encoding) and converting the textual data into numerical representations to prepare the data for further analysis. In step (203), the transformed data is fed into the causal discovery engine, that utilizes score-based and constraint-based causal discovery methods to identify potential causal relationships within the dataset. The causal discovery engine utilizes a ranking-based approach to select the optimal global causal graph from the various causal relationships identified during the causal relationship discovery process. Further, the causal discovery engine assigns attributes to the edges of the global causal graph, such as causal direction, strength, and confidence, to represent the nature and reliability of the identified relationships between variables.

Furthermore, in step (204), the identified causal relationships are used to generate a causal graph, visually representing the discovered causal relationships or networks. More particular, the causal graph provides a comprehensive visualization of the relationships between variables, with nodes representing the variables and edges indicating the causal links. Additionally, the SCDE comprises an editable interface, operable through a Subject Matter Expert (SME)-driven graphical tool, enabling domain experts to modify and refine the causal relationships within the graph based on domain-specific knowledge. The editable interface ensures that the causal graph is tailored to specific use cases, enhancing the system's adaptability and reliability.

In one embodiment of the invention, to ensure the accuracy and reliability of the global causal graph, the system (100) performs a verification process to detect and address logical inconsistencies within the causal relationships. A common issue encountered in causal graph construction is circular reasoning, where a variable serve as both the cause and the effect of another variable, leading to a logical loop. To mitigate this issue, the system (100) identifies such circular dependencies and remove them during the verification process, ensuring that the causal graph maintains a clear, consistent, and valid representation of the causal relationships between the variables. Further, by eliminating such logical inconsistencies, the system (100) ensures that the generated causal graph is reliable and is further refined by domain experts based on specific use cases and domain knowledge.

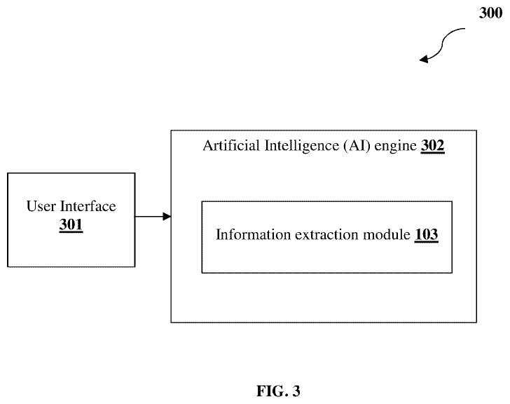

FIG. 3 illustrates a functional block diagram of the SME-driven graphing tool, in accordance with an embodiment of the present invention. The SME-driven graphing tool (300) comprises a user interface (301) enabling seamless interaction between the user and the global causal graph. The user interface (301) supports multiple input methods, including voice input and chat-based input. The voice input is processed through a speech-to-text service, allowing users to speak naturally, and the system (100) translates natural speech into text. The user interface (301) then processes this input to update the graph, allowing users to dynamically modify the causal relationships within the global causal graph, such as adding or deleting nodes or adjusting the direction of edges, or performing other structural alterations, thereby empowering subject matter experts to intuitively manage and refine the graph.

The SME-driven graphing tool (300) further comprises an Artificial Intelligence (AI) engine (302), for processing the user's, such as Subject Matter Experts (SMEs), input. The AI Engine (302) interprets the user's instructions, utilizing the Large Language Model (LLM) to understand the content and intent behind the user's speech or text. The AI Engine (302) converts natural language instructions into actionable changes within the global causal graph, ensuring that modifications align with the user's intent. Additionally, the SME-driven graphing tool (300) comprises the information extraction module (103) within the AI Engine (302), for extracting essential information from the user's input. More particularly, the information extraction module (103) identifies the intent of the user's instructions (for e.g., adding or modifying a causal link), as well as any entities referenced (such as specific variables or relationships). The information extracted by the information extraction module (103) ensures that the AI Engine (302) accurately interprets the user's input and apply the necessary changes to the global causal graph.

In an embodiment of the present invention, the SME-driven graphing tool (300) allows for exporting the modified causal graph in a machine-readable format, making it available for further analysis or integration into other systems. For instance, upon receiving a query from a user pertaining to a specific causal relationship, the system (100) utilizes the information extraction module (103) to process the query. The information extraction module (103) identifies key components such as the intent, treatment variables, target variables, table information, column information, and the underlying logic associated with the user's query.

Further, the system (100) utilizes a query-centric subgraph generation module (104), which dynamically extracts a subgraph from the global causal graph based on the user's query. The subgraph focus on the variables that are either parents or confounders of the target variable. Once the relevant subgraph is generated, the system (100) proceeds to the query refinement process. During the query refinement process, the subgraph output is iteratively refined into a structured SQL query to retrieve the requisite data for performing causal inference. The generated SQL query is subjected to a validation mechanism, and in cases of discrepancies or errors, a human-in-the-loop mechanism is activated to allow domain experts to verify, modify, or correct the query, facilitating alignment of the system's (100) outputs with real-world knowledge and practical applications, thereby enhancing the accuracy and relevance of the causal insights generated.

The refined query is further processed by the adaptive causal reasoning engine (105), that applies causal inference methodologies based on the information extracted from the query and the associated query-centric subgraph. The adaptive causal reasoning engine (105) uncovers causal relationships by analyzing the data and the structure of the causal graph, providing actionable insights into the cause-and-effect relationships between variables. The system (100) then communicates the findings through natural language generation, in a manner accessible to users with minimal technical expertise in causal inference. Furthermore, the visualization module (106) represent the results of the causal reasoning analysis through graphical and chart-based visualizations. These visualizations provide an intuitive depiction of the inferred causal relationships and the underlying data, enabling users to grasp complex cause-and-effect dynamics effectively. Moreover, by integrating textual explanations with visually informative representations, the system (100) facilitates an enhanced understanding of the causal reasoning results, thereby empowering users to make informed decisions based on the insights generated.

In an embodiment of the present invention, the information extraction module (103) leverage a Named Entity Recognition (NER) model and an Information Retrieval (IR) model based on the Retrieval-Augmented Generation (RAG) architecture. The dual-model approach integrates retrieval-based and generation-based techniques to accurately determine the user's intent, identify relevant entities such as table and column names, and establish the logic associated with foreign key relationships across multiple database tables. Further, by employing these methods, the system (100) ensures an advanced understanding of the context and specifics of user queries, including those that necessitate reasoning across diverse data sources. Further, upon submission of a user query, the NER model processes the input to identify the intent, that pertain to causal analysis, data retrieval, or conversational queries. The NER model further identifies key entities associated with the query, mapping them to corresponding table names and column attributes in the database schema, thereby facilitating the translation of natural language input into a formalized database query structure.

Subsequently, the identified entities and intent are utilized to generate an explicit question, a refined and structured representation of the initial user query. The explicit question is transformed into query embeddings, that are employed to search a knowledge repository. The knowledge repository comprises two primary datasets including a schema information, that contains metadata related to multiple tables, including column names and data types and historical queries, that store previously posed questions along with their corresponding, human-approved SQL queries.

The system (100) utilizes the knowledge repository to retrieve schema details and identify historical queries similar to the user's query. Further, by aligning current queries with previously addressed ones, the information extraction module (103) ensures the accuracy and contextual relevance of the results, accelerating the query generation process and maintaining consistency with prior solutions, thereby enhancing the reliability of the system (100). For example, consider a scenario where a user submits a query related to the sales data of a specific product across various regions. In this case, the Named Entity Recognition (NER) model processes the input query to identify key entities, such as “sales”, “product”, and “regions”. These identified entities are mapped to the corresponding columns in the database schema, such as “SalesAmount”, “ProductID”, and “Region”. Further, the Information Retrieval (IR) model converts the identified entities and query intent into a structured query embedding. The structured query embedding is utilized to search the knowledge repository, that contains relevant schema information and historical queries. Further, based on the query embedding, the system (100) identifies the relevant schema tables, such as SalesData, ProductInfo, and RegionDetails, and determines the specific columns related to the identified entities (for e.g., “ProductID”, “Region”, and “SalesAmount”). The system (100) further analyzes the relationships between these tables, identifying foreign key relationships, such as linking SalesData.ProductID to ProductInfo.ProductID and SalesData. RegionID to RegionDetails.RegionID. Further, once the relevant tables, columns, and relationships are determined, the system (100) searches the repository for similar historical queries. If the previous query related to “average sales by product across regions” exists in the repository, the system (100) retrieves the associated SQL query and adapts it to the user's current query, ensuring that the generated SQL query is accurate and contextually relevant, enhancing the efficiency and accuracy of the system's (100) response.

In an embodiment of the invention, the system (100) employs an iterative mechanism to refine user queries and generate accurate SQL queries for retrieving relevant data. The information extraction module (103) interacts with the natural language query processing module (102) to process user queries and extract pertinent elements, including input intent, table and column information, and logical conditions. These elements are formatted into structured prompts used by a Large Language Model (LLM) to dynamically generate SQL queries. The generated SQL queries are executed against the database to retrieve data points relevant to the user query. Further, if an error arises during query execution such as incorrect table associations or join conditions, the query is routed to a self-correction mechanism within the adaptive causal reasoning engine (105). The self-correction mechanism leverages retry logic within the LLM to correct the SQL query up to a user-defined limit. Further, if the retry attempts fail, the query is forwarded to a human correction mechanism, where human expertise is applied to refine the query. Multiple corrections and feedback provided by the human-in-the-loop are used to retrain the information extraction module (103) for improving subsequent query precision.

Further, the adaptive causal reasoning engine (105) processes the refined query to generate causal reasoning insights, that are contextualized using a query-centric subgraph generation module (104). The insights are derived by mapping the retrieved data to elements of the global causal graph, isolating causal relationships specific to the query.

In one embodiment of the invention, the system (100) dynamically selects an appropriate causal model based on parameters derived from a user query. The system (100) identifies and applies a causal modelling technique tailored to the user's analysis intent, target variable, and specified treatments or interventions. The selection process leverages advanced causal modelling methodologies and a Large Language Model (LLM) to interpret and process user inputs accurately. The natural language query processing module (102) processes the user query to extract essential parameters, and based on these parameters, the system (100) determines the most suitable causal modelling approach. Further, the system (100) supports multiple causal modeling techniques, including causal effect estimation, Root Cause Analysis (RCA), and what-if modeling. The causal effect estimation quantifies the impact of specific treatments on a target variable by calculating the expected variation in the outcome, resulting from the intervention. The root cause analysis identifies the fundamental causes of observed phenomena, enabling optimization and problem resolution. Conversely, the what-if models simulate potential outcomes by modifying treatments or conditions to predict effects under hypothetical scenarios. The adaptive causal reasoning engine (105) utilizes the LLM to analyze the extracted parameters, accurately interpret the user's intent, and select the optimal causal model.

In an embodiment of the invention, a method for data processing and causal inference to generate insights tailored to specific analytical questions is disclosed. The method comprises the steps of constructing a query-centric subgraph that encapsulates critical variables and interactions relevant to the analysis. The subgraph, together with associated data, is processed through a selected causal model to infer causal relationships and assess the impact of potential interventions. The method involves data alignment, wherein the input data is structured to focus on key variables and their interrelations, ensuring it is effectively prepared to address the analytical question. Subsequently, a query-centric subgraph is generated by isolating elements and interactions from the global causal graph that are most relevant to the user's query. The selected causal model is then applied to the query-centric subgraph to deduce insights, identifying potential causal relationships and predicting the outcomes of interventions or hypothetical scenarios. Moreover, by integrating automated subgraph generation with adaptive causal reasoning, the method ensures precise data processing and reliable inference of causal relationships, enhancing the efficiency and accuracy of data-driven decision-making in complex systems.

In an embodiment of the present invention, the system (100) comprises a narration module to enhance the accessibility and comprehensibility of causal insights. The narration module utilizes a Large Language Model (LLM) to translate analytical results into structured and coherent narratives. Upon generating causal reasoning insights, the narration module facilitates effective communication of these insights, enabling stakeholders, including non-technical users, to seamlessly comprehend and utilize the findings for informed decision-making.

In an embodiment of the invention, the system (100) employs a standardized JSON format to facilitate the efficient storage, organization, and integration of causal insights. The JSON format hierarchically structures the causal insights, metadata, and visualization parameters, ensuring seamless compatibility with multiple user interface components. The JSON-based storage allows for dynamic visualizations, interactive exploration of data, and smooth data sharing across platforms, thereby improving the accessibility, usability, and adaptability of the system for diverse applications.

In an embodiment of the present invention, the system (100) comprises a feedback mechanism to facilitate iterative refinement and continuous improvement of the system's (100) performance. The feedback mechanism enables users to actively contribute to the enhancement of system (100) outputs by providing corrective inputs at various stages of the data processing workflow. Specifically, users are enabled to rectify errors in information extraction, including inaccuracies in intent recognition, entity identification, and treatment detail extraction, thereby enhancing the accuracy and efficiency of the system (100).

In an embodiment of the invention, the system (100) further allows users to modify the question-centric subgraph by adding, removing, or adjusting nodes and edges, thereby enabling alignment with specific analytical objectives. Additionally, the system facilitates user to edits the generated SQL queries to ensure precision and contextual relevance. The edited SQL queries are stored in a database, thereby creating a repository of user inputs that serves as a training dataset for continuous optimization and improved system (100) performance.

Furthermore, the system (100) allows users to provide feedback on system-generated narratives and visualizations. This feedback mechanism facilitates the system's (100) adaptation to diverse user needs, thereby enhancing the accuracy, contextual relevance, and usability of the insights.

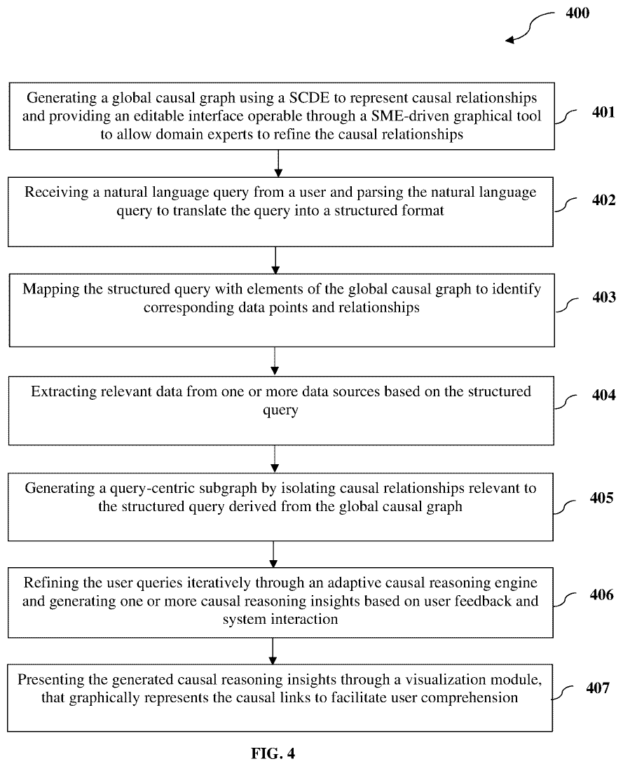

FIG. 4 illustrates a flowchart of a method for generating causal reasoning insights in real time, in accordance with an embodiment of the present invention. The method (400) comprises the steps of generating a global causal graph utilizing a Smart Causal Discovery Engine (SCDE) to represent causal relationships among multiple data points. Additionally, an editable interface is provided, operable through a Subject Matter Expert (SME)-driven graphical tool, to enable domain experts to refine the causal relationships by integrating domain-specific knowledge in step (401). In step (402), a natural language query is received from a user. The query is parsed to translate it into a structured format, thereby facilitating structured analysis and alignment of the query with the global causal graph. In step (403), the structured query is mapped to elements of the global causal graph to identify corresponding data points and relationships. In step (404), a query-centric subgraph is generated by isolating causal relationships from the global causal graph that are relevant to the structured query, ensuring that only the necessary data and relationships are analysed, simplifying the causal reasoning process. In step (405), relevant data is extracted from one or more data sources based on the structured query. In step (406), the user queries are refined iteratively through an adaptive causal reasoning engine and causal reasoning insights are generated based on user feedback and system interaction. Further, in step (407), the generated causal reasoning insights are presented through a visualization module, that graphically represents the causal links, thereby facilitating user comprehension by providing an intuitive depiction of causal relationships and their impacts.

In an embodiment of the invention, the method incorporates advanced natural language processing techniques to enhance the accuracy and relevance of the insights generated. The processing technique ensures the extraction of only the relevant causal intent while effectively excluding non-causal intent, thereby optimizing the analytical precision and relevance of the structured query.

The system (100) enables the generation of accurate and actionable insights through advanced causal reasoning, enhancing decision-making capabilities across various applications. The system (100) is user-friendly, offering intuitive interfaces with structured narratives and visualizations that simplify complex data insights, making them accessible to non-technical users. Additionally, the system (100) allows users to customize the analysis by modifying subgraphs, editing SQL queries, and selecting causal models to ensure results are tailored to specific needs. The system's (100) use of a standardized JSON format for storing insights ensures seamless integration with various platforms and facilitates dynamic interaction and visualization of data, making it highly adaptable to different use cases. The system (100) is integrated with a feedback mechanism that enables continuous refinement of the system's (100) performance. Furthermore, the system (100) supports diverse causal analysis techniques, including causal effect estimation, root cause analysis, and what-if modeling, making it applicable across multiple industries and domains.

Reference numbers:

| Components | Reference Numbers |
|---|---|
| System | 100 |
| Global causal graph creation | 101 |
| module | |
| Natural language query processing | 102 |
| module | |
| Information extraction module | 103 |
| Query-centric subgraph generation | 104 |
| module | |
| Adaptive causal reasoning engine | 105 |
| Visualization module | 106 |
| Smart Causal Discovery Engine | 200 |
| (SCDE) | |
| Subject Matter Expert (SME)- | 300 |
| driven graphical tool | |
| User Interface | 301 |

1. A system for generating causal reasoning insights in real time, the system (100) comprising:
a) a global causal graph creation module (101), to automatically generate a global causal graph representing causal relationships between plurality of data points using a Smart Causal Discovery Engine (SCDE) (200), wherein the global causal graph comprises an editable interface operable through a Subject Matter Expert (SME)-driven graphical tool (300), enabling one or more domain experts to modify and refine the causal relationships based on domain-specific knowledge;
b) a natural language query processing module (102) to receive plurality of user queries in natural language from a user, parse the user queries to extract relevant information, map the extracted information to elements of the global causal graph and generate the user queries into a structured, machine-readable format;
c) an information extraction module (103) coupled to the natural language query processing module (102), wherein the information extraction module (103) extracts the relevant information from one or more data sources based on the user queries;
d) a query-centric subgraph generation module (104) coupled to the global causal graph creation module (101), wherein the query-centric subgraph generation module (104) is configured to generate a query-centric subgraph by isolating the causal relationships relevant to the structured query derived from the global causal graph;
e) an adaptive causal reasoning engine (105) coupled to the query-centric subgraph generation module (104), wherein the adaptive causal reasoning engine (105) is configured to refine the user queries iteratively and generate one or more causal reasoning insights based on the query-centric subgraphs.

2. The system (100) as claimed in claim 1, wherein the natural language query processing module (102) utilizes a Large Language Model (LLM) to interpret the intent of the user query and translate the user query into the machine-readable format.

3. The system (100) as claimed in claim 1, wherein the information extraction module (103) extracts information from both the structured and unstructured data sources.

4. The system (100) as claimed in claim 1, wherein the global causal graph creation module (101) continuously updates the global causal graph based on real-time data inputs and allows refinement by one or more Subject Matter Experts (SMEs) to enhance accuracy.

5. The system (100) as claimed in claim 1, further comprises a visualization module (106) coupled to the adaptive causal reasoning engine (105), wherein the visualization module (106) presents the causal insights and relationships in a graphical format, allowing one or more users to visualize plurality of causal links.

6. The system (100) as claimed in claim 1, wherein the Smart Causal Discovery Engine (SCDE) is configured to:
a. normalize one or more categorical, numerical, string, and ordinal data values;
b. apply a score-based method and a constraint-based method to discover the global causal graph;
c. provide plurality of causal graphs based on the domain data;
d. assign one or more edge attributes for causal direction, strength, or confidence; and
e. visualize the causal graph in plurality of layouts and perform one or more graph analysis tasks.

7. A method for generating causal reasoning insights in real time, the method (400) comprising the steps of:
a. generating a global causal graph using a Smart Causal Discovery Engine (SCDE) to represent one or more causal relationships between plurality of data points, and providing an editable interface operable through a Subject Matter Expert (SME)-driven graphical tool to allow domain experts to refine the causal relationships based on domain-specific knowledge;
b. receiving a natural language query from a user and parsing the natural language query to translate the query into a structured format;
c. mapping the structured query with elements of the global causal graph to identify corresponding data points and relationships;
d. extracting relevant data from one or more data sources based on the structured query;
e. generating a query-centric subgraph by isolating the causal relationships relevant to the structured query derived from the global causal graph;
f. refining the user queries iteratively through an adaptive causal reasoning engine and generating one or more causal reasoning insights based on user feedback and system interaction; and
g. presenting the generated causal reasoning insights through a visualization module, that graphically represents plurality of causal links to facilitate user comprehension.

8. The method (200) as claimed in claim 7, wherein the natural language query is processed utilizing a trained Named Entity Recognition (NER) model and an Information Retrieval (IR) method to extract only the relevant causal intent and exclude any non-causal intent.

9. The method (200) as claimed in claim 7, further comprising the step of storing the generated causal insights in a JSON format.
